(19) United States
(12) Patent Application Publication
(10) Pub. No.: US 2019/0273225 A1
(43) Pub. Date: Sep. 5, 2019

(54) LITHIUM-ION RECHARGEABLE BATTERY, AND METHOD FOR PRODUCING LITHIUM-ION RECHARGEABLE BATTERY

(71) Applicants: SHOWA DENKO K.K., Tokyo (JP); SHOWA DENKO PACKAGING CO., LTD., Isehara-shi, Kanagawa (JP)

(72) Inventors: Akira SAKAWAKI, Ichihara-shi, Chiba (JP); Takaki YASUDA, Ichihara-shi, Chiba (JP); Koji MINAMITANI, Isehara-shi, Kanagawa (JP)

(73) Assignees: SHOWA DENKO K.K., Tokyo (JP); SHOWA DENKO PACKAGING CO., LTD., Isehara-shi, Kanagawa (JP)

(21) Appl. No.: 16/461,067

(22) PCT Filed: Oct. 11, 2017
(86) PCT No.: PCT/JP2017/036837

§ 371 Date: May 15, 2019

(30) Foreign Application Priority Data
Nov. 25, 2016 (JP) 2016-228631
May 11, 2017 (JP) 2017-094348

(51) Int. Cl. H01M 2/08; H01M 2/02; H01M 10/0585; H01M 10/04; H01M 10/0562

(52) U.S. Cl. CPC H01M 2/08; H01M 2/0287; H01M 10/0525; H01M 10/04; H01M 10/0562; H01M 10/0585

(57) ABSTRACT

A lithium-ion rechargeable battery 1 includes a battery part 10 which performs charging and discharging using lithium ions, and a shell 30 for housing the battery part 10 in the interior thereof. The shell 30 is constituted by thermally adhering a first laminated film 31 which includes a first metal layer 313 and a first thermo-adhesive resin layer 315, a second laminated film 32 which includes a second metal layer 323 and a second thermo-adhesive resin layer 325 by thermally adhering the first thermo-adhesive resin layer 315 and the second thermo-adhesive resin layer 325. Moreover, the positive electrode side of the battery part 10 is electrically connected to the first metal layer 313 of the first laminated film 31, and the negative electrode side of the battery part 10 is electrically connected to the second metal layer 323 of the second laminated film 32.

### TECHNICAL FIELD

The present invention relates to a lithium-ion rechargeable battery, and a method for producing the lithium-ion rechargeable battery.

### BACKGROUND ART

A lithium-ion rechargeable battery is known, which is provided with: a battery part including a positive electrode containing a positive-electrode active material, a negative electrode containing a negative-electrode active material, and an electrolyte having lithium-ion conductivity and interposed between the positive electrode and the negative electrode; and a shell that houses the battery part to seal the battery part against outside air or the like.

Here, the shell is required to have high barrier properties against gases, liquids and solids. In Patent Document 1, it is described that a shell is configured by using a laminated shell material formed by laminating a metallic foil layer and a thermo-adhesive resin layer and by thermally adhering thermo-adhesive films to each other.

Moreover, as the electrolyte constituting the battery part, an organic electrolytic solution or the like has been conventionally used. In contrast thereto, in Patent Document 2, it is described that a solid electrolyte made of an inorganic material is used as the electrolyte, and all of the negative electrode, the solid electrolyte and the positive electrode are configured with thin films.

### CITATION LIST

### Patent Literature

Patent Document 1: Japanese Patent Application Laid-Open Publication No. 2016-129091

Patent Document 2: Japanese Patent Application Laid-Open Publication No. 2013-73846

### SUMMARY OF INVENTION

### Technical Problem

Here, when the lithium-ion rechargeable battery was configured by using the battery part of the thin-film type and the shell to house the battery part inside thereof, it was necessary to have, separately from the shell, a substrate on which the battery part was to be laminated.

An object of the present invention is to simplify a configuration of a thin-film type lithium-ion rechargeable battery including a solid electrolyte.

### Solution to Problem

A lithium-ion rechargeable battery according to the present invention includes: a first laminated film including a first metal layer and a first resin layer laminated on the first metal layer to form a first exposed portion, where a part of the first metal layer is exposed, on one surface of the first metal layer; a battery part including a first polarity layer laminated on the first metal layer exposed at the first exposed portion to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and a second laminated film including a second metal layer and a second resin layer laminated on the second metal layer to form a second exposed portion, where a part of the second metal layer is exposed, on one surface of the second metal layer, the second laminated film sealing the battery part with the first laminated film in a state where the second metal layer is electrically connected to the second polarity layer at the second exposed portion.

In such a lithium-ion rechargeable battery, an entire periphery of the second laminated film is positioned inside or outside of an entire periphery of the first laminated film.

Moreover, the first metal layer constituting the first laminated film is configured with stainless steel and the second metal layer constituting the second laminated film is configured with aluminum.

Further, the first laminated film further includes a first insulation layer laminated on the first metal layer to form another first exposed portion, where a part of the first metal layer is exposed, on the other surface of the first metal layer, and the second laminated film further includes a second insulation layer laminated on the second metal layer to form another second exposed portion, where a part of the second metal layer is exposed, on the other surface of the second metal layer.

Still further, plural battery parts are provided, and the plural battery parts are disposed in a matrix form between the first laminated film and the second laminated film.

Then, the second polarity layer provided to the battery part and the second metal layer exposed at the second exposed portion of the second laminated film are in direct contact with each other.

Moreover, a method for producing a lithium-ion rechargeable battery according to the present invention includes: a process of depositing a first polarity layer occluding and releasing a lithium ion at a first polarity on a first metal layer exposed at a first exposed portion of a first laminated film, the first laminated film including the first metal layer and a first resin layer laminated on the first metal layer to form the first exposed portion, where a part of the first metal layer is exposed, on one surface of the first metal layer; a process of depositing a solid electrolyte layer on the first polarity layer, the solid electrolyte layer containing an inorganic solid electrolyte having lithium-ion conductivity; a process of depositing a second polarity layer on the solid electrolyte layer, the second polarity layer occluding and releasing a lithium ion with a second polarity, which is opposite to the first polarity; and a process of adhering the first resin layer and a second resin layer of a second laminated film including a second metal layer and the second resin layer laminated on the second metal layer to form a second exposed portion, where a part of the second metal layer is exposed, on one surface of the second metal layer in a state where the second laminated film is disposed to cause the second metal layer exposed at the second exposed portion to face the second polarity layer.

In such a method for producing lithium-ion rechargeable battery, each of the first polarity layer, the solid electrolyte layer and the second polarity layer is deposited by a sputtering method.

Moreover, in the deposition by the sputtering method, discharge and non-discharge are repeatedly performed in a short time.

### Advantageous Effects of Invention

According to the present invention, it is possible to simplify a configuration of a thin-film type lithium-ion rechargeable battery including a solid electrolyte.

### BRIEF DESCRIPTION OF DRAWINGS

FIGS. 1A and 1B are diagrams for illustrating an overall configuration of a lithium-ion rechargeable battery to which Exemplary embodiment 1 is applied;

FIG. 2 is a II-II cross-sectional view of FIG. 1A;

FIGS. 3A and 3B are perspective views of a first laminated film viewed from a front surface side and a back surface side;

FIG. 4 is a flowchart for illustrating a method for producing the lithium-ion rechargeable battery;

FIG. 5 is a front elevational view of a lithium-ion rechargeable battery to which Exemplary embodiment 2 is applied;

FIG. 6 is a cross-sectional view along the VI-VI line in FIG. 5;

FIG. 7 is a diagram for illustrating a modified example of Exemplary embodiment 1, which is a II-II cross-sectional view of FIG. 1A; and

FIG. 8 is a diagram for illustrating a modified example of Exemplary embodiment 2, which is the VI-VI cross-sectional view of FIG. 5.

### DESCRIPTION OF EMBODIMENTS

Hereinafter, exemplary embodiments according to the present invention will be described in detail with reference to attached drawings. Note that, the size, thickness or the like of each component in the drawings referenced in the following description will differ from the actual dimension in some cases.

### Exemplary Embodiment 1

### [Configuration of Lithium-Ion Rechargeable Battery]

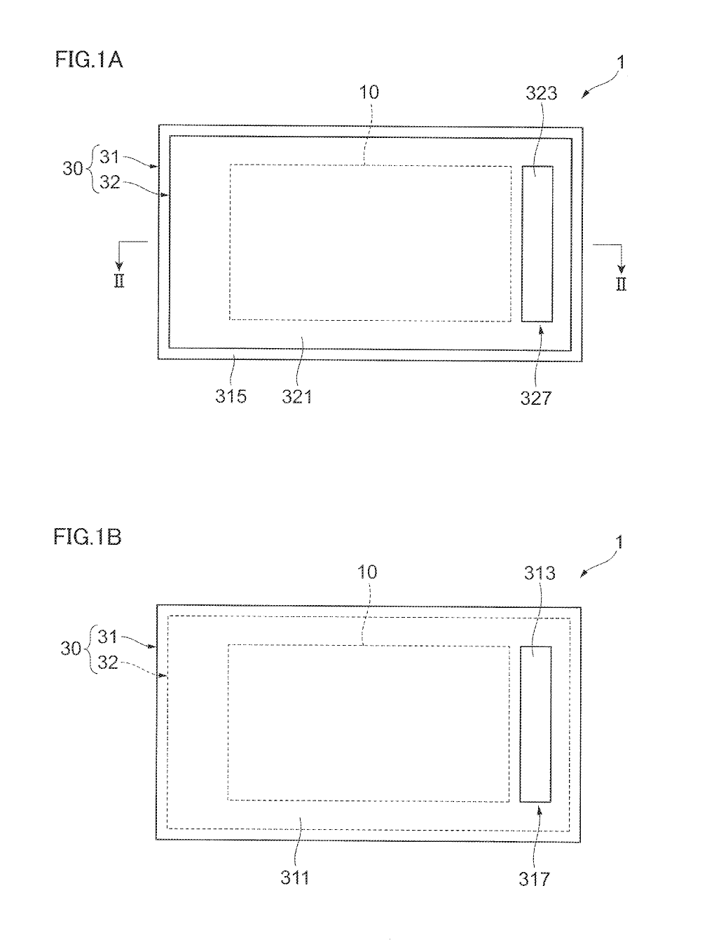

FIGS. 1A and 1B are diagrams for illustrating an overall configuration of a lithium-ion rechargeable battery 1 to which Exemplary embodiment 1 is applied. Here, FIG. 1A is a diagram in which the lithium-ion rechargeable battery 1 is viewed from the front, and FIG. 1B is a diagram in which the lithium-ion rechargeable battery 1 is viewed from the back.

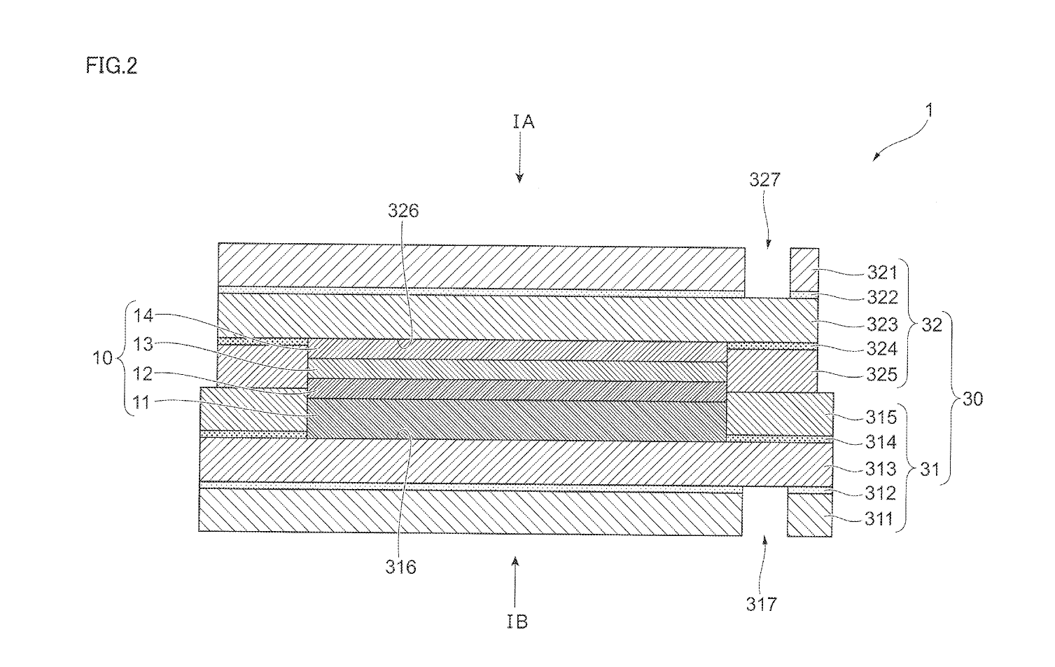

Moreover, FIG. 2 shows a II-II cross-sectional view of FIG. 1A, namely, a longitudinal section of the lithium-ion rechargeable battery 1. Note that FIG. 1A is a diagram viewing FIG. 2 from the IA direction, and FIG. 1B is a diagram viewing FIG. 2 from the IB direction.

The lithium-ion rechargeable battery 1 of the exemplary embodiment includes: a battery part 10 that performs charge and discharge using lithium ions; and a shell 30 that seals the battery part 10 against outside air or the like by housing the battery part 10 in the interior thereof. The lithium-ion rechargeable battery 1 of the exemplary embodiment shows a rectangular-parallelepiped shape (in actuality, a card shape) as a whole.

### [Configuration of Battery Part]

First, a configuration of the battery part 10 will be described.

The battery part 10 includes: a positive electrode layer 11; a solid electrolyte layer 12 laminated on the positive electrode layer 11; a negative electrode layer 13 laminated on the solid electrolyte layer 12; and a negative electrode collector layer 14 laminated on the negative electrode layer 13. Here, the positive electrode layer 11 positioned on one end portion of the battery part 10 (the lower side in FIG. 2) is in contact with a first metal layer 313 provided to a first laminated film 31, which will be described later. In contrast thereto, the negative electrode collector layer 14 positioned on the other end portion of the battery part 10 (the upper side in FIG. 2) is in contact with a second metal layer 323 provided to a second laminated film 32, which will be described later.

Next, each constituent of the battery part 10 will be described in more detail.

### (Positive Electrode Layer)

The positive electrode layer 11 as an example of a first polarity layer is not particularly limited as long as the layer is a solid thin film that contains a positive-electrode active material occluding and releasing lithium ions with a positive polarity as an example of a first polarity, and, for example, those configured with various kinds of materials, such as oxides, sulfides or phosphorus oxides containing at least one kind of metal selected from manganese (Mn), cobalt (Co), nickel (Ni), iron (Fe), molybdenum (Mo) and vanadium (V), may be used. In the exemplary embodiment, as the positive electrode layer 11, Li₂Mn₂O₄ was used.

The thickness of the positive electrode layer 11 can be set in the range of, for example, 10 nm or more and 40 μm or less. When the thickness of the positive electrode layer 11 is less than 10 nm, the capacity of the battery part 10 (the lithium-ion rechargeable battery 1) to be obtained becomes too small, and impractical. On the other hand, when the thickness of the positive electrode layer 11 exceeds 40 μm, it takes too much time to form the layer, and thereby, the productivity is deteriorated. In the exemplary embodiment, the thickness of the positive electrode layer 11 was set to 600 nm.

Moreover, it does not matter whether the positive electrode layer 11 includes crystal structures or is in the amorphous state without including the crystal structures; however, in the point that expansion and contraction associated with occluding and releasing of lithium ions are more isotropic, it is preferable that the positive electrode layer 11 is in the amorphous state.

Further, as the manufacturing method of the positive electrode layer 11, known deposition methods, such as various kinds of PVD (physical vapor deposition) or various kinds of CVD (chemical vapor deposition), may be used; however, in terms of production efficiency, it is desirable to use the sputtering method (sputtering). In this case, in accordance with a sputtering target to be used in forming the positive electrode layer 11, the DC sputtering method or the RF sputtering method may be used. However, in the case where the above-described Li₂Mn₂O₄ is used for the positive electrode layer 11, it is preferable to adopt the RF sputtering method.

### (Solid Electrolyte Layer)

The solid electrolyte layer 12 is not particularly limited as long as being a solid thin film composed of an inorganic material having lithium-ion conductivity, and those configured with various kinds of materials, such as oxides, nitrides or sulfides, may be used. In the exemplary embodiment, as the solid electrolyte layer 12, LiPON (LiₓPO_{y}N_{z}), which was obtained by replacing a part of oxygen in Li₃PO₄ with nitrogen, was used.

The thickness of the solid electrolyte layer 12 can be set in the range of, for example, 10 nm or more and 10 μm or less. When the thickness of the solid electrolyte layer 12 is less than 10 nm, in the obtained lithium-ion rechargeable battery 1, leakage between the positive electrode layer 11 and the negative electrode layer 13 is likely to occur. On the other hand, when the thickness of the solid electrolyte layer 12 exceeds 10 μm, the moving distance of lithium ion is elongated, and thereby, the charge and discharge rate is reduced. In the exemplary embodiment, the thickness of the solid electrolyte layer 12 was set to 200 nm.

Moreover, it does not matter whether the solid electrolyte layer 12 includes crystal structures or is in the amorphous state without including the crystal structures; however, in the point that expansion and contraction due to heat are more isotropic, it is preferable that the solid electrolyte layer 12 is in the amorphous state.

Further, as the manufacturing method of the solid electrolyte layer 12, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets used in forming the solid electrolyte layer 12 are insulating bodies, it is preferable to adopt the RF sputtering method.

### (Negative Electrode Layer)

The negative electrode layer 13 as an example of a second polarity layer is not particularly limited as long as the layer is a solid thin film that contains a negative-electrode active material occluding and releasing lithium ions with a negative polarity as an example of a second polarity, and, for example, carbon (C) or silicon (Si) can be used. In the exemplary embodiment, as the negative electrode layer 13, silicon (Si) added with boron (B) was used.

The thickness of the negative electrode layer 13 can be set in the range of, for example, 10 nm or more and 40 μm or less. When the thickness of the negative electrode layer 13 is less than 10 nm, the capacity of the battery part 10 (the lithium-ion rechargeable battery 1) to be obtained becomes too small, and impractical. On the other hand, when the thickness of the negative electrode layer 13 exceeds 40 μm, it takes too much time to form the layer, and thereby, the productivity is deteriorated. In the exemplary embodiment, the thickness of the negative electrode layer 13 was set to 100 nm.

Moreover, it does not matter whether the negative electrode layer 13 includes crystal structures or is in the amorphous state without including the crystal structures; however, in the point that expansion and contraction associated with occluding and releasing of lithium ions are more isotropic, it is preferable that the negative electrode layer 13 is in the amorphous state.

Further, as the manufacturing method of the negative electrode layer 13, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets for forming the negative electrode layer 13 are semiconductors, it is preferable to adopt the DC sputtering method.

### (Negative Electrode Collector Layer)

The negative electrode collector layer 14 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals. In the exemplary embodiment, as the negative electrode collector layer 14, titanium (Ti) was used.

The thickness of the negative electrode collector layer 14 can be set in the range of, for example, 5 nm or more and 50 μm or less. When the thickness of the negative electrode collector layer 14 is less than 5 nm, the power collection function is deteriorated, to thereby become impractical. On the other hand, when the thickness of the negative electrode collector layer 14 exceeds 50 μm, it takes too much time to form the layer, and thereby, the productivity is deteriorated. In the exemplary embodiment, the thickness of the negative electrode collector layer 14 was set to 200 nm.

Moreover, as the manufacturing method of the negative electrode collector layer 14, known deposition methods, such as various kinds of PVD (physical vapor deposition) or various kinds of CVD (chemical vapor deposition), may be used; however, in terms of production efficiency, it is desirable to use the sputtering method (sputtering). In this case, since the sputtering target for forming the negative electrode collector layer 14 is a metal (Ti), it is preferable to adopt the DC sputtering method.

### [Configuration of Shell]

Subsequently, a configuration of the shell 30 will be described.

The shell 30 includes the first laminated film 31 and the second laminated film 32. The first laminated film 31 and the second laminated film 32 are disposed to face each other across the battery part 10, and the first laminated film 31 and the second laminated film 32 are thermally adhered to each other around the entire circumference of the battery part 10, to thereby seal the battery part 10. Of these, the first laminated film 31 is integrated with the battery part 10 by laminating respective layers constituting the battery part 10 (from the positive electrode layer 11 to the negative electrode collector layer 14) on the surface of the first laminated film 31 located on the inside of the shell 30 (on the upper side in FIG. 2). In contrast thereto, as to the second laminated film 32, only the negative electrode collector layer 14 of the battery part 10 is in contact with the surface of the second laminated film 32 located on the inside of the shell 30 (on the lower side in FIG. 2). Consequently, the battery part 10 is integrated with the second laminated film 32 via the first laminated film 31; however, though the battery part 10 and the first laminated film 32 are in the state of being in contact with each other and fixed, the battery part 10 and the second laminated film 32 are in the state of being in contact with each other but not fixed.

### [First Laminated Film]

To begin with, the first laminated film 31 will be described.

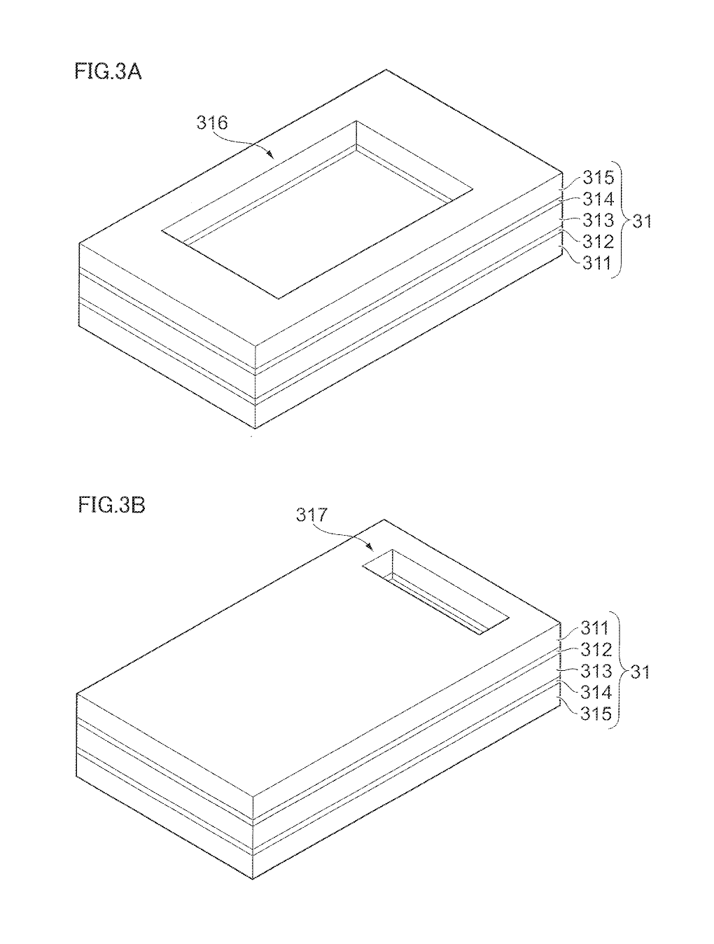

FIGS. 3A and 3B show diagrams for illustrating the configuration of the first laminated film 31: FIG. 3A shows a perspective view that is viewed from the front side (in FIG. 2, from above); and FIG. 3B shows a perspective view that is viewed from the back side (in FIG. 2, from below). Hereinafter, the configuration of the first laminated film 31 will be described with reference to FIGS. 3A and 3B in addition to FIGS. 1A, 1B and 2.

The first laminated film 31 is configured by laminating a first heat-resistant resin layer 311, a first outside adhesion layer 312, the first metal layer 313, a first inside adhesion layer 314 and a first thermo-adhesive resin layer 315 in a film-like shape in this order. In other words, the first laminated film 31 is configured by bonding the first heat-resistant resin layer 311, the first metal layer 313 and the first thermo-adhesive resin layer 315 via the first outside adhesion layer 312 and the first inside adhesion layer 314.

Moreover, on a formation surface side of the first laminated film 31, on which the first thermo-adhesive resin layer 315 is formed (interior in the shell 30), there is provided a first inside exposed part 316 where a part of one surface of the first metal layer 313 (inside surface) is exposed due to absence of the first thermo-adhesive resin layer 315 and the first inside adhesion layer 314. Here, the first inside exposed part 316 as an example of a first exposed portion is provided on a center portion side of the first laminated film 31 in the surface direction and has a rectangular shape. Then, all around the first inside exposed part 316, there are formed side walls by the first inside adhesion layer 314 and the first thermo-adhesive resin layer 315.

Further, on a formation surface side of the first laminated film 31, on which the first heat-resistant resin layer 311 is formed (outside in the shell 30), there is provided a first outside exposed part 317 where the other surface of the first metal layer 313 (an outside surface) is exposed due to absence of the first heat-resistant resin layer 311 and the first outside adhesion layer 312. Here, the first outside exposed part 317 is provided on one end portion side of the first laminated film 31 in the longitudinal direction and has a rectangular shape. Then, all around the first outside exposed part 317, there are formed side walls by the first outside adhesion layer 312 and the first heat-resistant resin layer 311.

Next, each constituent of the first laminated film 31 will be described in more detail.

### (First Heat-Resistant Resin Layer)

The first heat-resistant resin layer 311 as an example of a first insulation layer is the outermost layer in the shell 30, and a heat-resistant resin, which has high resistance to sticking from the outside, abrasion or the like, and is not melted at the adhesive temperature in thermally adhering the first thermo-adhesive resin layer 315, is used. Here, as the first heat-resistant resin layer 311, it is preferable to use a heat-resistant resin having a melting point not less than 10° C. higher than a melting point of a thermo-adhesive resin constituting the first thermo-adhesive resin layer 315, and particularly preferable to use a heat-resistant resin having a melting point not less than 20° C. higher than the melting point of the thermo-adhesive resin. Moreover, in the exemplary embodiment, as will be described later, the first metal layer 313 also serves as the positive electrode of the battery part 10; therefore, in terms of safety, an insulating resin having high electrical resistance value is used as the first heat-resistant resin layer 311.

As the first heat-resistant resin layer 311, though not being particularly limited, examples thereof include polyamide films or polyester films, and oriented films thereof are preferably used. Among them, in terms of moldability and strength, it is particularly preferable to use a biaxially oriented polyamide film, a biaxially oriented polyester film or a multi-layered film containing these biaxially stretched films, and further, it is preferable to use a multi-layered film made by bonding the biaxially oriented polyamide film and the biaxially oriented polyester film. As the polyamide film, though not being particularly limited, examples thereof include a 6-polyamide film, a 6,6-polyamide film and an MXD polyamide film. Moreover, as the biaxially oriented polyester film, examples include a biaxially oriented polybutylene terephthalate (PBT) film and a biaxially oriented polyethylene terephthalate (PET) film. In the exemplary embodiment, as the first heat-resistant resin layer 311, a nylon film (the melting point: 220° C.) was used.

The thickness of the first heat-resistant resin layer 311 can be set in the range of 9 μm or more to 50 μm or less. When the thickness of the first heat-resistant resin layer 311 is less than 9 μm, it becomes difficult to secure the sufficient strength as the shell 30 of the battery part 10. On the other hand, when the thickness of the first heat-resistant resin layer 311 exceeds 50 μm, since the battery becomes thick, it is not preferable, and the production costs are increased. In the exemplary embodiment, the thickness of the first heat-resistant resin layer 311 was set to 25 μm.

### (First Outside Adhesion Layer)

The first outside adhesion layer 312 adheres the first heat-resistant resin layer 311 and the first metal layer 313. As the first outside adhesion layer 312, for example, it is preferable to use two-pack curable type polyester-urethane resin by polyester resin as a base resin and polyfunctional isocyanate compound as a curing agent, or an adhesive agent containing polyether-urethane resin. In the exemplary embodiment, as the first outside adhesion layer 312, the two-pack curable type polyester-urethane adhesive agent was used.

### (First Metal Layer)

The first metal layer 313 has a role, when the shell 30 is configured by using the first laminated film 31, in preventing oxygen, moisture or the like from entering the battery part 10, which is disposed inside of the shell 30, from the outside thereof (barriering the battery part 10). Moreover, as will be described later, the first metal layer 313 further has a role as a substrate when the battery part 10 is formed by using the sputtering method, a role as a positive electrode collector layer (positive internal electrode) electrically connected to the positive electrode layer 11 of the battery part 10, and a role as a positive external electrode electrically connected to a load provided outside (not shown). Therefore, as the first metal layer 313, metallic foil having conductivity is used.

As the first metal layer 313, though not being particularly limited, for example, aluminum foil, copper foil, Nickel foil, stainless foil, clad foil thereof, annealed foil or unannealed foil thereof and the like are preferably used. However, considering that the first metal layer 313 is used as the substrate in forming the battery part 10 by the sputtering method, it is preferable to use stainless foil having high mechanical strength. Moreover, metallic foil, which is obtained by plating with conductive metals, such as nickel, tin, copper, chrome and the like, may be used. In the exemplary embodiment, as the first metal layer 313, the stainless foil made of SUS 304 was used.

The thickness of the first metal layer 313 can be set in the range of 20 μm or more and 200 μm or less. When the thickness of the first metal layer 313 is less than 20 μm, a pinhole or breaking is likely to occur in rolling or heat sealing in manufacturing the metallic foil, and in addition, the electrical resistance value when being used as the electrode is increased. On the other hand, when the thickness of the first metal layer 313 exceeds 200 μm, since the battery becomes thick, it is not preferable, and the production costs are increased. In the exemplary embodiment, the thickness of the first metal layer 313 was set to 30 μm.

### (First Inside Adhesion Layer)

The first inside adhesion layer 314 adheres the first metal layer 313 and the first thermo-adhesive resin layer 315. As the first inside adhesion layer 314, it is preferable to use an adhesive agent made of, for example, a polyurethane adhesive agent, an acrylic adhesive agent, an epoxy adhesive agent, a polyolefine adhesive agent, an elastomer adhesive agent, a fluorine adhesive agent or the like. Among them, it is preferable to use the acrylic adhesive agent or the polyolefine adhesive agent; in this case, the barrier properties of the first laminated film 31 against water vapor can be improved. Moreover, it is preferable to use an adhesive agent of acid-denaturated polypropylene, polyethylene or the like. In the exemplary embodiment, as the first inside adhesion layer 314, the acid-denaturated polypropylene adhesive agent was used.

### (First Thermo-Adhesive Resin Layer)

The first thermo-adhesive resin layer 315 as an example of a first resin layer is an innermost layer in the shell 30, and, as the thermo-adhesive resin layer 315, a thermoplastic resin, which has high resistance to the materials constituting respective layers of the battery part 10 and is melted at the above-described adhesive temperature, to thereby adhere to a second thermo-adhesive resin layer 325 (details thereof will be described later) of the second laminated film 32, is used. Moreover, in the exemplary embodiment, as described above, the first metal layer 313 also serves as the positive electrode of the battery part 10; therefore, in terms of safety, an insulating resin having high electrical resistance value is used as the first thermo-adhesive resin layer 315.

As the first thermo-adhesive resin layer 315, though not being particularly limited, for example, polyethylene, polypropylene, olefin copolymer, acid denaturation and ionomer thereof and so forth are preferably used. Here, examples of the olefin copolymer include: EVA (ethylene vinyl acetate copolymer); EAA (ethylene acrylic acid copolymer); and EMAA (ethylene methacrylic acid copolymer). Moreover, as long as relationship of melting point with the first heat-resistant resin layer 311 can be satisfied, a polyamide film (for example, nylon 12) or a polyimide film can also be used. In the exemplary embodiment, as the first thermo-adhesive resin layer 315, a cast polypropylene film (the melting point: 165° C.) was used.

The thickness of the first thermo-adhesive resin layer 315 can be set in the range of 20 μm or more and 80 μm or less. When the thickness of the first thermo-adhesive resin layer 315 is less than 20 μm, pinholes are likely to occur. On the other hand, when the thickness of the first thermo-adhesive resin layer 315 exceeds 80 μm, since the battery becomes thick, it is not preferable, and the production costs are increased. In the exemplary embodiment, the thickness of the first thermo-adhesive resin layer 315 was set to 30 μm.

### [Second Laminated Film]

Subsequently, the second laminated film 32 will be described.

The second laminated film 32 is configured by laminating a second heat-resistant resin layer 321, a second outside adhesion layer 322, the second metal layer 323, a second inside adhesion layer 324 and a second thermo-adhesive resin layer 325 in a film-like shape in this order. In other words, the second laminated film 32 is configured by bonding the second heat-resistant resin layer 321, the second metal layer 323 and the second thermo-adhesive resin layer 325 via the second outside adhesion layer 322 and the second inside adhesion layer 324.

Moreover, on a formation surface side of the second laminated film 32, on which the second thermo-adhesive resin layer 325 is formed (interior in the shell 30), there is provided a second inside exposed part 326 where a part of one surface of the second metal layer 323 (inside surface) is exposed due to absence of the second thermo-adhesive resin layer 325 and the second inside adhesion layer 324. Here, the second inside exposed part 326 as an example of a second exposed portion is provided on a center portion side of the second laminated film 32 and has a rectangular shape. Then, all around the second inside exposed part 326, there are formed side walls by the second inside adhesion layer 324 and the second thermo-adhesive resin layer 325.

Further, on a formation surface side of the second laminated film 32, on which the second heat-resistant resin layer 321 is formed (outside in the shell 30), there is provided a second outside exposed part 327 where a part of the other surface of the second metal layer 323 (an outside surface) is exposed due to absence of the second heat-resistant resin layer 321 and the second outside adhesion layer 322. Here, the second outside exposed part 327 is provided on one end portion side of the second laminated film 32 in the longitudinal direction and has a rectangular shape. Then, all around the second outside exposed part 327, there are formed side walls by the second outside adhesion layer 322 and the second heat-resistant resin layer 321.

As described above, the structure of the second laminated film 32 including each exposed part is almost the same as the structure of the first laminated film 31 shown in FIG. 3.

Next, each constituent of the second laminated film 32 will be described in more detail.

### (Second Heat-Resistant Resin Layer)

The second heat-resistant resin layer 321 as an example of a second insulation layer is the outermost layer in the shell 30, and a heat-resistant resin, which has high resistance to sticking from the outside, abrasion or the like, and is not melted at the adhesive temperature in thermally adhering the second thermo-adhesive resin layer 325, is used. Moreover, in the exemplary embodiment, as will be described later, the second metal layer 323 also serves as the negative electrode of the battery part 10; therefore, in terms of safety, an insulating resin having high electrical resistance value is used as the second heat-resistant resin layer 321.

Then, as the second heat-resistant resin layer 321, the material described in the above first heat-resistant resin layer 311 can be used. At this time, the second heat-resistant resin layer 321 and the first heat-resistant resin layer 311 may be configured with the same material, or may be configured with different materials. Moreover, the thickness of the second heat-resistant resin layer 321 may also be the same as or different from the thickness of the first heat-resistant resin layer 311. In the exemplary embodiment, as the second heat-resistant resin layer 321, a 25 μm-thick nylon film (the melting point: 220° C.) was used.

### (Second Outside Adhesion Layer)

The second outside adhesion layer 322 adheres the second heat-resistant resin layer 321 and the second metal layer 323.

Then, as the second outside adhesion layer 322, the material described in the above first outside adhesion layer 312 can be used. At this time, the second outside adhesion layer 322 and the first outside adhesion layer 312 may be configured with the same material, or may be configured with different materials. In the exemplary embodiment, as the second outside adhesion layer 322, the two-pack curable type polyester-urethane adhesive agent was used.

### (Second Metal Layer)

The second metal layer 323 has a role, when the shell 30 is formed by using the second laminated film 32, in preventing oxygen, moisture or the like from entering the battery part 10, which is disposed inside of the shell 30, from the outside thereof (barriering the battery part 10). Moreover, as will be described later, the second metal layer 323 further has a role as a negative internal electrode electrically connected to the negative electrode collector layer 14 of the battery part 10, and a role as a negative external electrode of the battery part 10, the negative external electrode being electrically connected to a load provided outside (not shown). Therefore, as the second metal layer 323, metallic foil having conductivity is used. Note that, different from the above-described first metal layer 313, the second metal layer 323 does not have a role as a substrate in forming the battery part 10 by using the sputtering method.

Then, as the second metal layer 323, the material described in the above first metal layer 313 can be used. At this time, the second metal layer 323 and the first metal layer 313 may be configured with the same material, or may be configured with different materials. Moreover, the thickness of the second metal layer 323 may also be the same as or different from the thickness of the first metal layer 313. In the exemplary embodiment, as the second metal layer 323, 40 μm-thick aluminum foil made of the A8021H-O material prescribed by JIS H4160 was used.

### (Second Inside Adhesion Layer)

The second inside adhesion layer 324 adheres the second metal layer 323 and the second thermo-adhesive resin layer 325.

Then, as the second inside adhesion layer 324, the material described in the above first inside adhesion layer 314 can be used. At this time, the second inside adhesion layer 324 and the first inside adhesion layer 314 may be configured with the same material, or may be configured with different materials. In the exemplary embodiment, as the second inside adhesion layer 324, the acid-denaturated polypropylene adhesive agent was used.

### (Second Thermo-Adhesive Resin Layer)

The second thermo-adhesive resin layer 325 as an example of a second resin layer is an innermost layer in the shell 30, and, as the thermo-adhesive resin layer 315, a thermoplastic resin, which has high resistance to the materials constituting respective layers of the battery part 10 and is melted at the above-described adhesive temperature, to thereby adhere to the first thermo-adhesive resin layer 315 of the first laminated film 31, is used. Moreover, in the exemplary embodiment, as described above, the second metal layer 323 also serves as the negative electrode of the battery part 10; therefore, in terms of safety, an insulating resin having high electrical resistance value is used as the second thermo-adhesive resin layer 325.

Then, as the second thermo-adhesive resin layer 325, the material described in the above first thermo-adhesive resin layer 315 can be used. At this time, the second thermo-adhesive resin layer 325 and the first thermo-adhesive resin layer 315 may be configured with the same material, or may be configured with different materials as long as the melting points of the two materials are close and the materials can be melted. Moreover, the thickness of the second thermo-adhesive resin layer 325 may also be the same as or different from the thickness of the first thermo-adhesive resin layer 315. In the exemplary embodiment, as the second thermo-adhesive resin layer 325, a 30 μm-thick cast polypropylene film (the melting point: 165° C.) was used.

### [Dimensions and Positional Relationship Between First Laminated Film and Second Laminated Film]

As shown in FIG. 1, each of the first laminated film 31 and the second laminated film 32 constituting the shell 30 shows a rectangular shape when viewed from the front or the back. Then, the first laminated film 31 and the second laminated film 32 are thermally adhered in a state of being overlapped so that the short side of the first laminated film 31 and the short side of the second laminated film 32 are substantially parallel, and the long side of the first laminated film 31 and the long side of the second laminated film 32 are substantially parallel.

Here, the short-side length of the first laminated film 31 is longer than the short-side length of the second laminated film 32. Moreover, the long-side length of the first laminated film 31 is longer than the long-side length of the second laminated film 32. Then, in the shell 30, the first laminated film 31 and the second laminated film 32 are thermally adhered in a state of being overlapped so that an entire periphery of the second laminated film 32 is positioned inside of an entire periphery of the first laminated film 31.

### [Electrical Connection Structure in Lithium-Ion Rechargeable Battery]

Next, the electrical connection structure in the aforementioned lithium-ion rechargeable battery 1 will be described.

First, in the battery part 10, the positive electrode layer 11, the solid electrolyte layer 12, the negative electrode layer 13 and the negative electrode collector layer 14 are electrically connected in this order.

Moreover, the positive electrode layer 11 of the battery part 10 is electrically connected to a portion, of one surface (inside surface) of the first metal layer 313 provided to the first laminated film 31, exposed to the first inside exposed part 316. In addition, a part of the other surface (outside surface) of the first metal layer 313 provided to the first laminated film 31 is exposed at the first outside exposed part 317 to the outside; the portion can be electrically connected to the load (not shown) provided outside.

In contrast thereto, the negative electrode collector layer 14 of the battery part 10 is electrically connected to a portion, of one surface (inside surface) of the second metal layer 323 provided to the second laminated film 32, exposed to the second inside exposed part 326. In addition, a part of the other surface (outside surface) of the second metal layer 323 provided to the second laminated film 32 is exposed at the second outside exposed part 327 to the outside; the portion can be electrically connected to the load (not shown) provided outside.

Then, the first metal layer 313 provided to the first laminated film 31 is electrically insulated from the second metal layer 323 provided to the second laminated film 32 by the first thermo-adhesive resin layer 315 provided to the first laminated film 31 and the second thermo-adhesive resin layer 325 provided to the second laminated film 32. At this time, in the shell 30, the first thermo-adhesive resin layer 315 of the first laminated film 31 and the second thermo-adhesive resin layer 325 of the second laminated film 32 are thermally adhered so that an entire periphery of the second laminated film 32 is positioned inside of an entire periphery of the first laminated film 31, as described above. This makes it difficult to generate a short circuit in the battery part 10 due to the contact between the first metal layer 313 and the second metal layer 323 exposed at an end surface of a side portion of the shell 30.

### [Method for Producing Lithium-Ion Rechargeable Battery]

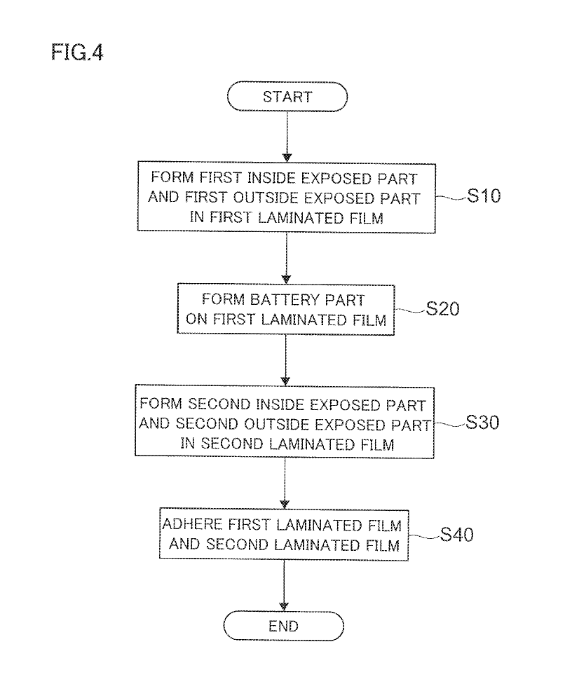

FIG. 4 is a flowchart for illustrating a method of producing the lithium-ion rechargeable battery 1 shown in FIG. 1, and so forth.

### (First Laminated Film Exposed Portion Formation Process)

To begin with, from the first laminated film 31 formed by bonding the first heat-resistant resin layer 311, the first metal layer 313 and the first thermo-adhesive resin layer 315 via the first outside adhesion layer 312 and the first inside adhesion layer 314, a part of the first thermo-adhesive resin layer 315 and a part of the first heat-resistant resin layer 311 are removed. Consequently, in the first laminated film 31, the first inside exposed part 316 and the first outside exposed part 317 are formed (step 10).

### (Battery Part Formation Process)

Next, in the first laminated film 31 where the first inside exposed part 316 and the first outside exposed part 317 are formed, the battery part 10 is formed on the first metal layer 313 exposed at the first inside exposed part 316 by the sputtering method (step 20). Here, in step 20, on the first metal layer 313, the positive electrode layer 11, the solid electrolyte layer 12, the negative electrode layer 13 and the negative electrode collector layer 14 are laminated in this order. Note that the details of step 20 will be described later.

### (Second Laminated Film Exposed Portion Formation Process)

Moreover, from the second laminated film 32 formed by bonding the second heat-resistant resin layer 321, the second metal layer 323 and the second thermo-adhesive resin layer 325 via the second outside adhesion layer 322 and the second inside adhesion layer 324, a part of the second thermo-adhesive resin layer 325 and a part of the second heat-resistant resin layer 321 are removed. Consequently, in the second laminated film 32, the second inside exposed part 326 and the second outside exposed part 327 are formed (step 30).

### (Adhesion Process)

Subsequently, for example, into a working box filled with inert gas, such as N₂ gas or the like, the first laminated film 31 on which the battery part 10 is formed and the second laminated film 32 are introduced. Then, in the working box, the negative electrode collector layer 14 of the battery part 10 formed on the first metal layer 313 exposed at the first inside exposed part 316 in the first laminated film 31 and the second metal layer 323 exposed at the second inside exposed part 326 in the second laminated film 32 are made to face each other. At this time, the first thermo-adhesive resin layer 315 in the first laminated film 31 and the second thermo-adhesive resin layer 325 in the second laminated film 32 face each other at outer entire circumference of the periphery of the battery part 10. Moreover, at this time, the first laminated film 31 and the second laminated film 32 are positioned so that the entire periphery of the second laminated film 32 is positioned inside of the entire periphery of the first laminated film 31.

Thereafter, in a state where the interior of the working box is set to the negative pressure, the first thermo-adhesive resin layer 315 in the first laminated film 31 and the second thermo-adhesive resin layer 325 in the second laminated film 32 are adhered to each other at outer entire circumference of the periphery of the battery part 10 while being pressurized and heated (step 40). Then, due to the first thermo-adhesive resin layer 315 and the second thermo-adhesive film 325 being thermally adhered, the lithium-ion rechargeable battery 1 including the battery part 10 and the shell 30 that seals the battery part 10 is obtained.

At this time, the first metal layer 313 of the first laminated film 31 and the positive electrode layer 11 of the battery part 10 are in a state of being joined (integrated) by deposition by the sputtering method. Moreover, the second metal layer 323 of the second laminated film 32 and the negative electrode collector layer 14 of the battery part 10 are brought into a state of being tightly adhered to each other by thermally adhering the first thermo-adhesive resin layers 315 of the first laminated film 31 and the second thermo-adhesive resin layer 325 of the second laminated film 32 to each other under the negative pressure.

### [Method for Producing Battery Part]

Now, producing procedures of the battery part 10 in the aforementioned step 20 will be described by taking specific examples.

### (Formation of Positive Electrode Layer)

To begin with, the first laminated film 31 in which the first inside exposed part 316 and the first outside exposed part 317 are formed was placed in a deposition chamber (chamber) in a not-shown sputtering device. At this time, the first inside exposed part 316 of the first laminated film 31 is made to face the sputtering target, and portions other than the first inside exposed part 316 (portions where the first thermo-adhesive resin layer 315 exists) are masked. After the first laminated film 31 was placed in the chamber, Ar gas containing 5% O₂ gas was introduced to set the pressure in the chamber at 0.8 Pa. And then, by use of a sputtering target having a composition of Li₂Mn₂O₄, formation (deposition) of the positive electrode layer 11 was performed on the first metal layer 313 by the RF sputtering method.

The depositing temperature is limited by the melting points of the materials used for the first laminated film 31. Therefore, the temperature of the first laminated film 31 in being deposited is preferably set to 300° C. or less, and further preferably, set to 200° C. or less. In the exemplary embodiment, the temperature of the substrate, namely, the first metal layer 313 was prevented from exceeding 150° C. by repeating discharge and standby (non-discharge) in a short time. The film composition of the positive electrode layer 11 thus obtained was Li₂Mn₂O₄, the thickness thereof was 600 nm, and the crystal structure thereof was amorphous.

### (Formation of Solid Electrolyte Layer)

Next, N₂ gas was introduced to set the pressure in the chamber at 0.8 Pa. And then, by use of a sputtering target having a composition of Li₃PO₄, formation (deposition) of the solid electrolyte layer 12 was performed on the positive electrode layer 11 by the RF sputtering method. At this time, same as the formation of the positive electrode layer 11, the temperature of the substrate, namely, the first metal layer 313 was prevented from exceeding 150° C. by repeating discharge and standby (non-discharge) in a short time. The film composition of the solid electrolyte layer 12 thus obtained was LiPON, the thickness thereof was 200 nm, and the crystal structure thereof was amorphous.

### (Formation of Negative Electrode Layer)

Subsequently, Ar gas was introduced to set the pressure in the chamber at 0.8 Pa. And then, by use of a sputtering target composed of silicon (Si) doped with boron (B) (a P-type Si sputtering target), formation (deposition) of the negative electrode layer 13 was performed on the solid electrolyte layer 12 by the DC sputtering method. At this time, same as the case of the positive electrode layer 11, the temperature of the substrate, namely, the first metal layer 313 was prevented from exceeding 150° C. by repeating discharge and standby (non-discharge) in a short time. The film composition of the negative electrode layer 13 thus obtained was Si doped with B, the thickness thereof was 100 nm, and the crystal structure thereof was amorphous.

### (Formation of Negative Electrode Collector Layer)

Further, in a state where Ar gas was introduced to set the pressure in the chamber at 0.8 Pa, by use of a sputtering target composed of titanium (Ti), formation (deposition) of the negative electrode collector layer 14 was performed on the negative electrode layer 13 by the DC sputtering method. At this time, same as the case of the positive electrode layer 11, the temperature of the substrate, namely, the first metal layer 313 was prevented from exceeding 150° C. by repeating discharge and standby (non-discharge) in a short time. The film composition of the negative electrode collector layer 14 thus obtained was Ti, and the thickness thereof was 200 nm.

By the above-described procedures, on the first metal layer 313 exposed at the first inside exposed part 316 of the first laminated film 31, the battery part 10 was formed. Then, the first laminated film 31 on which the battery part 10 was formed was taken out of the chamber. Here, in the exemplary embodiment, since each layer constituting the battery part 10 is formed by the sputtering method on the first metal layer 313 of the first laminated film 31, the first laminated film 31 and the battery part 10 are integrated by the first metal layer 313 and the positive electrode layer 11.

### Conclusion of Exemplary Embodiment 1

As described above, according to the exemplary embodiment, since the first metal layer 313 of the first laminated film 31 constituting the shell 30 is made to have a function of sealing the battery part 10 and a function as the positive electrode of the battery part 10, and the second metal layer 323 of the second laminated film 32 constituting the shell 30 is made to have a function of sealing the battery part 10 and a function as the negative electrode of the battery part 10, it is possible to simplify the configuration of the thin-film type lithium-ion rechargeable battery 1 including the solid electrolyte layer 12. Here, in the exemplary embodiment, since the first laminated film 31 and the battery part 10 are integrated, it is possible to suppress positional deviation between the shell 30 and the battery part 10 in the lithium-ion rechargeable battery 1.

### Exemplary Embodiment 2

In Exemplary embodiment 1, the lithium-ion rechargeable battery 1 was configured by housing a single (one) battery part 10 in the shell 30. In contrast thereto, in the exemplary embodiment, plural battery parts 10 are housed inside of the shell 30 and the plural battery parts 10 are connected in parallel by use of the shell 30, to thereby configure the lithium-ion rechargeable battery 1 having a larger capacity. Note that, in the exemplary embodiment, those similar to the exemplary embodiment 1 are assigned with same reference signs, and detailed descriptions thereof will be omitted.

### [Configuration of Lithium-Ion Rechargeable Battery]

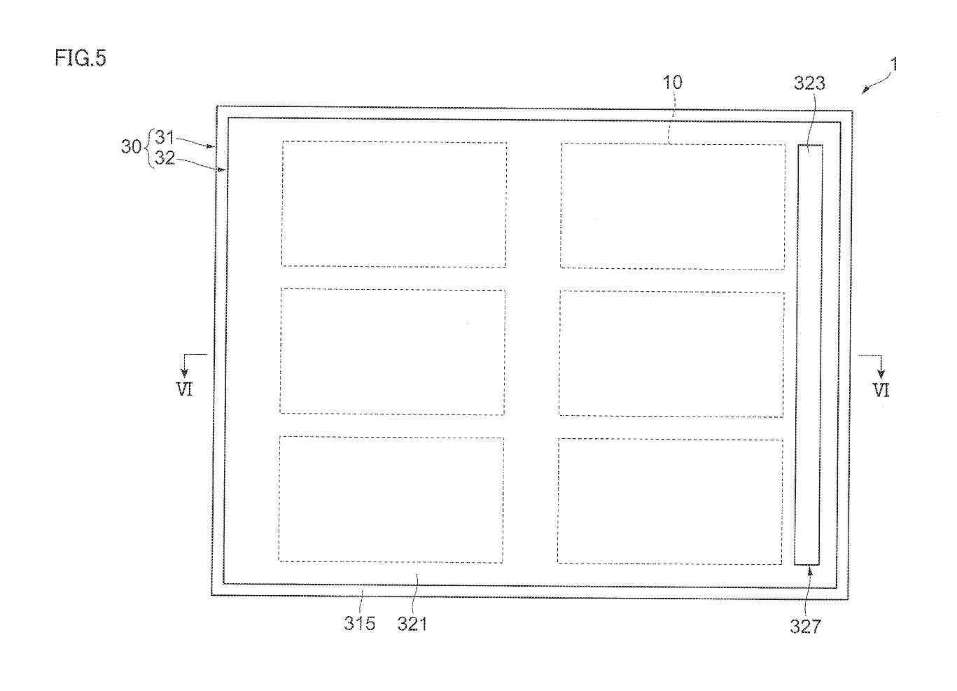

FIG. 5 is a diagram for illustrating an overall configuration of the lithium-ion rechargeable battery 1 to which Exemplary embodiment 2 is applied. Here, FIG. 5 is a diagram in which the lithium-ion rechargeable battery 1 is viewed from the front.

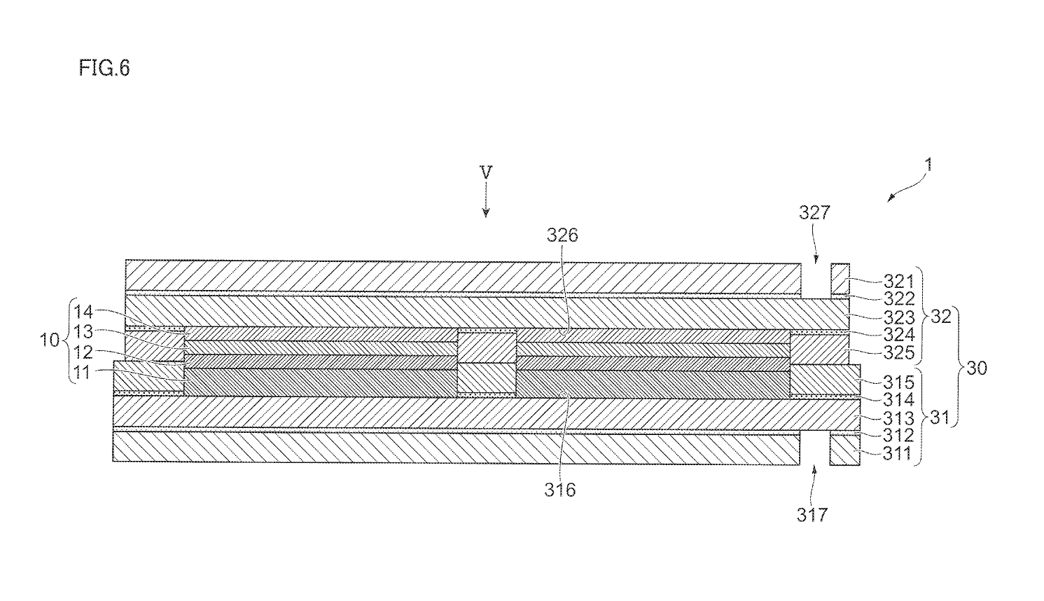

Moreover, FIG. 6 shows a VI-VI cross-sectional view of FIG. 5, namely, a longitudinal section of the lithium-ion rechargeable battery 1. Note that FIG. 5 is a diagram viewing FIG. 6 from the V direction.

The lithium-ion rechargeable battery 1 of the exemplary embodiment includes: plural (here, six) battery parts 10 that perform charge and discharge using lithium ions; and a shell 30 that seals the plural battery parts 10 against outside air or the like by housing the battery part 10 in the interior thereof. The lithium-ion rechargeable battery 1 of the exemplary embodiment also shows a rectangular-parallelepiped shape (in actuality, a card shape) as a whole.

Then, the six battery parts 10 are, as shown in FIG. 5, disposed in a form of a matrix in which there are three rows in the short side and two rows in the long side of the shell 30 so that the long side of the shell 30 corresponds to the long side of each battery part 10 and the short side of the shell 30 corresponds to the short side of each battery part 10.

### [Configuration of Battery Part]

The configuration of each of the six battery parts 10 is the same as that described in Exemplary embodiment 1. In other words, each of the battery parts 10 includes: the positive electrode layer 11; the solid electrolyte layer 12 laminated on the positive electrode layer 11; the negative electrode layer 13 laminated on the solid electrolyte layer 12; and the negative electrode collector layer 14 laminated on the negative electrode layer 13.

### [Configuration of Shell]

Subsequently, a configuration of the shell 30 will be described.

The shell 30 includes the first laminated film 31 and the second laminated film 32. The first laminated film 31 and the second laminated film 32 are disposed to face each other across the six battery parts 10, and the first laminated film 31 and the second laminated film 32 are thermally adhered to each other around the entire circumference of the six battery parts 10, to thereby seal the battery parts 10. Consequently, the basic configuration of the shell 30 is the same as that in Exemplary embodiment 1.

However, it is different from Exemplary embodiment 1 in that, on a formation surface side of the first laminated film 31, on which the first thermo-adhesive resin layer 315 is formed (interior in the shell 30), there are provided first inside exposed parts 316, where a part of one surface of the first metal layer 313 (inside surface) is exposed due to absence of the first thermo-adhesive resin layer 315 and the first inside adhesion layer 314, at six locations (3×2) corresponding to the six battery parts 10. Moreover, it is different from Exemplary embodiment 1 in that, on a formation surface side of the second laminated film 32, on which the second thermo-adhesive resin layer 325 is formed (interior in the shell 30), there are provided second inside exposed parts 326, where a part of one surface of the second metal layer 323 (inside surface) is exposed due to absence of the second thermo-adhesive resin layer 325 and the second inside adhesion layer 324, at six locations (3×2) corresponding to the six battery parts 10.

### [Electrical Connection Structure in Lithium-Ion Rechargeable Battery]

In the exemplary embodiment, the positive electrode layer 11 of each of the six battery parts 10 is electrically connected to a portion, of one surface (inside surface) of the first metal layer 313 provided to the first laminated film 31, exposed to the first inside exposed part 316. Moreover, a part of the other surface (outside surface) of the first metal layer 313 provided to the first laminated film 31 is exposed at the first outside exposed part 317 to the outside; the part can be electrically connected to an external electrode (a positive electrode, which is not shown).

In contrast thereto, the negative electrode collector layer 14 of each of the six battery parts 10 is electrically connected to a portion, of one surface (inside surface) of the second metal layer 323 provided to the second laminated film 32, exposed to the second inside exposed part 326. Moreover, a part of the other surface (outside surface) of the second metal layer 323 provided to the second laminated film 32 is exposed at the second outside exposed part 327 to the outside; the part can be electrically connected to an external negative electrode (not shown).

### Conclusion of Exemplary Embodiment 2

As described above, in the exemplary embodiment, addition to the effects described in Exemplary embodiment 1, it is possible to increase the capacity by connecting the plural battery parts 10 in parallel by use of the first metal layer 313 of the first laminated film 31 and the second metal layer 323 of the second laminated film 32.

### Modified Example of Exemplary Embodiment 1

In the lithium-ion rechargeable battery 1 of Exemplary embodiment 1, the battery part 10 included the negative electrode collector layer 14; however, the negative electrode collector layer 14 is not essential.

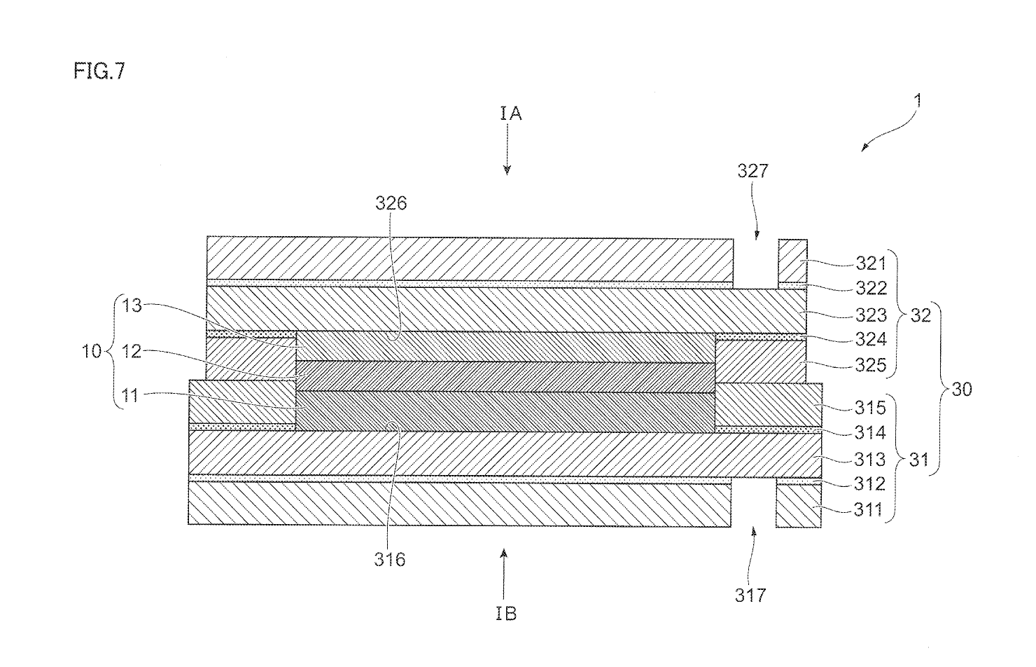

FIG. 7 is a diagram for illustrating a modified example of Exemplary embodiment 1, which is a II-II cross-sectional view of FIG. 1A.

In the modified example of Exemplary embodiment 1, the battery part 10 includes: the positive electrode layer 11 laminated on the first metal layer 313 exposed at the first inside exposed part 316 of the first laminated film 31; the solid electrolyte layer 12 laminated on the positive electrode layer 11; and the negative electrode layer 13 laminated on the solid electrolyte layer 12. Then, the negative electrode collector layer 13 positioned on the other end portion of the battery part 10 (the upper side in FIG. 7) is in direct contact with the second metal layer 323 exposed at the second inside exposed part 326 of the second laminated film 32.

By adopting such a configuration, as compared to the configuration described in Exemplary embodiment 1, it is possible to simplify the structure of the lithium-ion rechargeable battery 1.

### Modified Example of Exemplary Embodiment 2

In the lithium-ion rechargeable battery 1 of Exemplary embodiment 2, each of the plural battery parts 10 included the negative electrode collector layer 14; however, the negative electrode collector layer 14 is not essential therein.

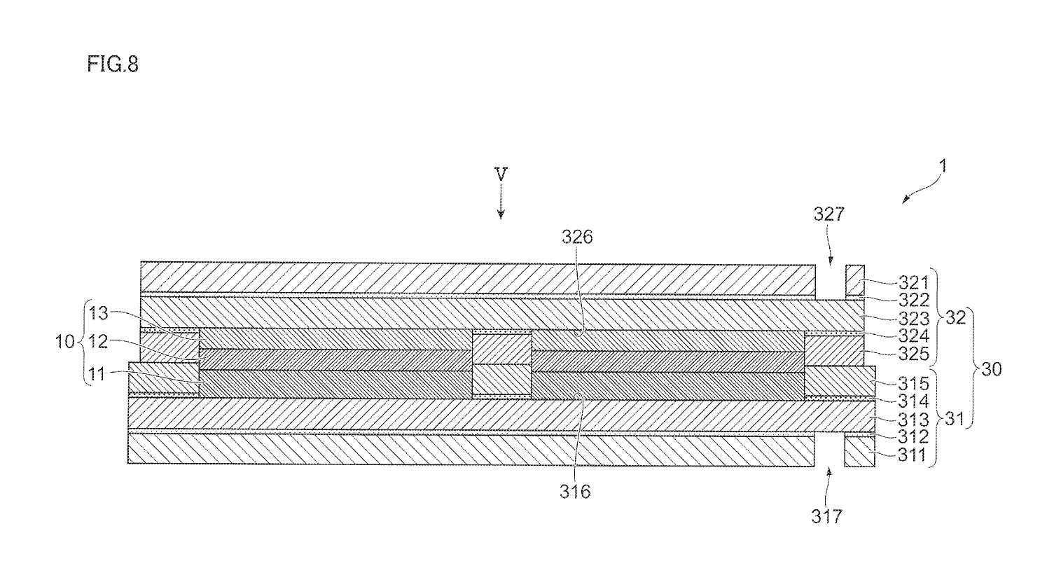

FIG. 8 is a diagram for illustrating a modified example of Exemplary embodiment 2, which is the VI-VI cross-sectional view of FIG. 5.

In the modified example of Exemplary embodiment 2, each of the battery parts 10 includes: the positive electrode layer 11 laminated on the first metal layer 313 exposed at the first inside exposed part 316 of the first laminated film 31; the solid electrolyte layer 12 laminated on the positive electrode layer 11; and the negative electrode layer 13 laminated on the solid electrolyte layer 12. Then, the negative electrode collector layer 13 positioned on the other end portion of each of the battery parts 10 (the upper side in FIG. 8) is in direct contact with the second metal layer 323 exposed at the second inside exposed part 326 of the second laminated film 32.

By adopting such a configuration, as compared to the configuration described in Exemplary embodiment 2, it is possible to simplify the structure of the lithium-ion rechargeable battery 1.

### <Others>

Note that, in Exemplary embodiments 1 and 2, on the first metal layer 313 of the first laminated film 31, the positive electrode layer 11, the solid electrolyte layer 12, the negative electrode layer 13 and the negative electrode collector layer 14 were laminated in this order, to thereby form the battery part 10; however, the laminating order is not limited thereto. For example, the battery part 10 may be formed by laminating the negative electrode layer 13, the solid electrolyte layer 12 and the positive electrode layer 11 on the first metal layer 313 of the first laminated film 31 in this order. In this case, the positive electrode collector layer that is in contact with the second metal layer 323 of the second laminated film 32 may be provided on the positive electrode layer 11, but is not essential.

Moreover, in Exemplary embodiments 1 and 2, the first laminated film 31 constituting the shell 30 included the first heat-resistant resin layer 311; however, it is sufficient that the first laminated film 31 is provided with the first metal layer 313 and the first thermo-adhesive resin layer 315, and the first heat-resistant resin layer 311 is not essential. Moreover, in Exemplary embodiments 1 and 2, the second laminated film 32 constituting the shell 30 included the second heat-resistant resin layer 321; however, it is sufficient that the second laminated film 32 is provided with the second metal layer 323 and the second thermo-adhesive resin layer 325, and the second heat-resistant resin layer 321 is not essential.

Further, in Exemplary embodiments 1 and 2, the first laminated film 31 and the second laminated film 32 were overlapped so that the entire periphery of the second laminated film 32 was positioned inside of the entire periphery of the first laminated film 31; however, the present invention is not limited thereto. In other words, the first laminated film 31 and the second laminated film 32 may be overlapped so that the entire periphery of the second laminated film 32 is positioned outside of the entire periphery of the first laminated film 31.

Still further, in Exemplary embodiments 1, 2 and the modified examples thereof, the battery part 10 (the negative electrode collector layer 14 or the negative electrode layer 13) and the second laminated film 32 (the second metal layer 323) were brought into contact with each other in the state of not being fixed; however, the present invention is not limited thereto, and it may be possible to fix the positional relationship of these components by use of, for example, a conductive adhesive agent or the like.

### REFERENCE SIGNS LIST

1 Lithium-ion rechargeable battery
10 Battery part
11 Positive electrode layer
12 Solid electrolyte layer
13 Negative electrode layer
14 Negative electrode collector layer
30 Shell
31 First laminated film
32 Second laminated film
311 First heat-resistant resin layer
312 First outside adhesion layer
313 First metal layer
314 First inside adhesion layer
315 First thermo-adhesive resin layer
316 First inside exposed part
317 First outside exposed part
321 Second heat-resistant resin layer
322 Second outside adhesion layer
323 Second metal layer
324 Second inside adhesion layer
325 Second thermo-adhesive resin layer
326 Second inside exposed part
327 Second outside exposed part

1. A lithium-ion rechargeable battery comprising:
a first laminated film including a first metal layer and a first resin layer laminated on the first metal layer to form a first exposed portion, where a part of the first metal layer is exposed, on one surface of the first metal layer;
a battery part including a first polarity layer laminated on the first metal layer exposed at the first exposed portion to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and
a second laminated film including a second metal layer and a second resin layer laminated on the second metal layer to form a second exposed portion, where a part of the second metal layer is exposed, on one surface of the second metal layer, the second laminated film sealing the battery part with the first laminated film in a state where the second metal layer is electrically connected to the second polarity layer at the second exposed portion.

2. The lithium-ion rechargeable battery according to claim 1, wherein an entire periphery of the second laminated film is positioned inside or outside of an entire periphery of the first laminated film.

3. The lithium-ion rechargeable battery according to claim 1, wherein the first metal layer constituting the first laminated film is configured with stainless steel and the second metal layer constituting the second laminated film is configured with aluminum.

4. The lithium-ion rechargeable battery according to claim 1, wherein
the first laminated film further includes a first insulation layer laminated on the first metal layer to form another first exposed portion, where a part of the first metal layer is exposed, on the other surface of the first metal layer, and
the second laminated film further includes a second insulation layer laminated on the second metal layer to form another second exposed portion, where a part of the second metal layer is exposed, on the other surface of the second metal layer.

5. The lithium-ion rechargeable battery according to claim 1, wherein a plurality of the battery parts is provided, and the plurality of battery parts is disposed in a matrix form between the first laminated film and the second laminated film.

6. The lithium-ion rechargeable battery according to claim 1, wherein the second polarity layer provided to the battery part and the second metal layer exposed at the second exposed portion of the second laminated film are in direct contact with each other.

7. A method for producing a lithium-ion rechargeable battery, comprising:
a process of depositing a first polarity layer occluding and releasing a lithium ion at a first polarity on a first metal layer exposed at a first exposed portion of a first laminated film, the first laminated film including the first metal layer and a first resin layer laminated on the first metal layer to form the first exposed portion, where a part of the first metal layer is exposed, on one surface of the first metal layer;
a process of depositing a solid electrolyte layer on the first polarity layer, the solid electrolyte layer containing an inorganic solid electrolyte having lithium-ion conductivity;
a process of depositing a second polarity layer on the solid electrolyte layer, the second polarity layer occluding and releasing a lithium ion with a second polarity, which is opposite to the first polarity; and
a process of adhering the first resin layer and a second resin layer of a second laminated film including a second metal layer and the second resin layer laminated on the second metal layer to form a second exposed portion, where a part of the second metal layer is exposed, on one surface of the second metal layer in a state where the second laminated film is disposed to cause the second metal layer exposed at the second exposed portion to face the second polarity layer.

8. The method for producing a lithium-ion rechargeable battery according to claim 7, wherein each of the first polarity layer, the solid electrolyte layer and the second polarity layer is deposited by a sputtering method.

9. The method for producing a lithium-ion rechargeable battery according to claim 8, wherein, in the deposition by the sputtering method, discharge and non-discharge are repeatedly performed in a short time.
